(19) United States
(12) Patent Application Publication
(10) Pub. No.: US 2018/0262121 A1
(43) Pub. Date: Sep. 13, 2018

(54) METHOD FOR ERROR HANDLING AND PARTIAL REDUNDANCY IN PARALLEL INVERTERS BY MEANS OF INPUT SWITCHES

(71) Applicant: FECON GMBH, Flensburg (DE)

(72) Inventor: LORENZ FEDDERSEN, FLENSBURG (DE)

(21) Appl. No.: 15/566,584

(22) PCT Filed: Apr. 13, 2015
(86) PCT No.: PCT/EP2015/057958

§ 371 Date: Oct. 13, 2017

(51) Int. Cl. H02M 7/42; H02M 1/00; H02M 5/02

(52) U.S. Cl. CPC H02M 7/42; H02J 3/383; H02M 5/02; H02M 1/00

(57) ABSTRACT

A method for handling errors in an inverter device for converting DC current from DC current generators into AC current, the inverter device comprising a plurality of parallel DC current branches, each DC current branch comprising an inverter and a DC current input for connection to one of the DC current generators. As a result of an error detected in one of the inverters by the inverter device, the DC current input of the faulty inverter is connected to the DC current input of an error-free inverter.

The present invention relates to a method for handling errors in an inverter device for converting DC current from DC current generators into AC current, the inverter device comprising a plurality of parallel DC current branches, each DC current branch comprising an inverter and a DC current input for connection to one of the DC current generators. The invention also relates to a method for handling errors in a current converter device for inverting AC current from AC current generators, and to an inverter or current converter device designed for carrying out the particular method.

Inverter devices for photovoltaic systems generally comprise a plurality of inverters connected in parallel, a corresponding inverter being provided for each DC current generator (solar cell field). If an error or defect is detected in an inverter, the DC current branch corresponding to the faulty inverter is automatically switched off or disconnected. Until a member of the service team arrives, the corresponding DC current generator cannot be used, thus reducing the power of the photovoltaic system.

U.S. Pat. No. 6,800,964 B2 discloses a method for optimising the efficiency of an inverter device comprising a plurality of inverters connected in parallel, in which a contactor is provided between the DC current branches of two inverters in each case, which contactor is either open or closed depending on the build-up of power in the different DC current branches, in which, by closing a contactor, a DC current generator is switched over from an active error-free inverter to another active error-free inverter.

The object of the invention is to provide a method which reduces the negative effects of an error occurring in an inverter or converter.

The invention solves this problem by means of the features of the independent claims. As a result of an error detected in one of the inverters by the inverter device, the DC current input of the faulty inverter is connected to the DC current input of an error-free inverter. In this way, the functional inverter can take up at least some of the power of the defective inverter, until the service engineer arrives. At least some of the current generated by the DC current generator assigned to the defective inverter can therefore also be used whilst an inverter is not working.

The error detected by the inverter device is preferably transmitted to the central remote monitoring system via a remote monitoring connection and the DC current inputs are connected by a control signal that is transmitted from the central remote monitoring system via the remote monitoring connection. This allows qualified staff who are often not immediately or constantly available at the site of the inverter device to instantly respond to the failure of an inverter.

The connection between the DC current inputs can preferably only be re-opened by the intervention of a service engineer at the site of the inverter device. This prevents unintentional opening of the connection before a service engineer has ensured on-site that the faulty inverter has been replaced or repaired.

The invention comprises hybrid systems having different types of DC current generators, in particular solar electricity generators and energy accumulators, for example batteries. In the event of relatively high solar power, one or more of the inverters are preferably operated in the opposite direction as converters in order to charge the energy accumulator(s). In the event of relatively low solar power, the inverters are preferably operated to deliver energy stored in the energy accumulator(s) to AC mains.

One variant of the invention relates to a method for handling errors in a current converter device for converting AC current from AC current generators, the current converter device comprising a plurality of parallel AC current branches, each AC current branch comprising a converter and an AC current input for connection to one of the AC current generators. In this variant, the invention is characterised in that, as a result of an error detected in one of the converters by the current converter device, the AC current input of the faulty converter is connected to the AC current input of an error-free converter.

The invention will be explained hereinafter on the basis of preferred embodiments and with reference to the accompanying drawings, in which:

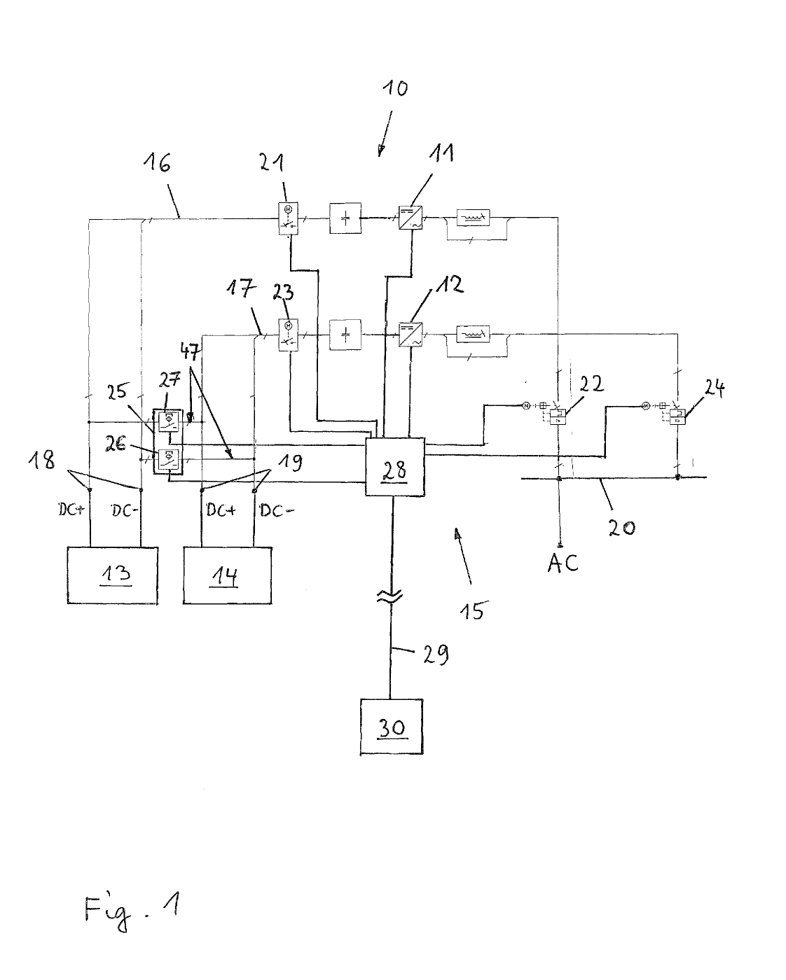

FIG. 1-4 show a schematic circuit diagram for a photovoltaic system in various embodiments of the invention; and

FIG. 5 shows a schematic circuit diagram for a wind turbine in one embodiment of the invention.

The photovoltaic system 10 according to FIG. 1 comprises a plurality of DC current generators 13, 14, in particular solar electricity generators, and an inverter device 15 for converting the DC current generated by the DC current generators 13, 14 into AC current. Each solar electricity generator 13, 14 comprises at least one solar cell field or solar panel. In general, each solar electricity generator 13, 14 contains a plurality of solar cells or photovoltaic cells.

The inverter device 15 comprises a plurality of inverters 11, as the central components. Each inverter 11, 12 is connected to a corresponding DC current input 18, 19 by means of lines that form corresponding DC current branches 16, 17. A corresponding DC current generator 13, 14 can be connected to each DC current input 18, 19. After the inverters 11, 12 have converted the DC current, the AC current generated is delivered to AC mains, power consumers and/or power storage mediums, for example, by means of one or more AC current outputs 20. A controllable switch 21, 22 and 23, 24 is arranged on the DC current side and on the AC current side of each inverter 11, 12, respectively, so as to be able to individually disconnect the inverters 11, 12 from the inverter device 15, for example in the event of a defect.

The two DC current branches 16, 17 and the two DC current inputs 18, 19 can be connected to one another by means of a controllable switch 25 via a bridge 47. This will be explained in more detail in the following. The switch 25 preferably has two poles, i.e. it switches the positive pole of the DC current branches 16, 17 by means of a switching element 27 and the negative pole thereof by means of a switching element 26, the switching elements 26, 27 preferably being coupled. The switches 21 to 25 and the inverters 11, 12 can be controlled by means of an electronic control device 28. The electronic control device 28 is, for example, a signal processor or microprocessor and can be arranged in the inverter device 15 or generally at any suitable location in the photovoltaic system 10. The electronic control device 28 is also designed to be able to measure and detect an error in one of the inverters 11, 12.

The electronic control device 28 is connected via a remote monitoring connection 29 to a central remote maintenance system 30 that is arranged at a distance from the photovoltaic system 10. The central remote maintenance system 30 can be operated by the supplier of the inverter device 15, for example. The central remote maintenance system 30 is used in particular by service engineers to monitor a multiplicity of inverter devices of photovoltaic systems that are independent of one another and spatially separate from one another. The remote monitoring connection 29 can be formed by a cable connection or can be formed either entirely or partially wirelessly by means of radio communication.

The inverter circuit 15 operates as follows: during normal operation of the system, the switches 21 to 24 are closed and the switch 25 is open. The DC current generated by the DC current generator 13 is conducted to the inverter 11 by means of the DC current input 18 and the DC current branch 16, where it is converted into AC current and conducted to the AC current output 20. The DC current generated by the DC current generator 14 is conducted to the inverter 12 by means of the DC current input 19 and the DC current branch 17, where it is converted into AC current and conducted to the AC current output 20.

If the control device 28 detects an error or defect in one of the inverters 11, 12, the following steps are carried out: it should be assumed here without limitation that an error state is detected at the inverter 12. The control device 28 first controls the switches 23 and 24 arranged upstream and downstream, respectively, of the corresponding inverter 12 in order to open said switches and to therefore disconnect the corresponding inverter 12 from the inverter device 15 on both sides, i.e. on the DC current side and on the AC current side. Furthermore, the control device 28 sends an error signal to the central remote monitoring system 30. In the central remote monitoring system 30, after receiving the error signal and checking the situation in the inverter device 15, qualified staff can trigger the central remote monitoring system 30 to send a switching signal to the inverter device 15. After receiving the switching signal from the central remote monitoring system 30, the control device 28 controls the switch 25, preferably without the possibility of intervention from the outside, in order to close it and therefore to connect the DC current branches 16 and 17 and the DC current inputs 18 and 19 to one another. In this state, current generated by both DC current generators 13, 14 can be converted by the intact inverter 11, i.e. the functional inverter 11 can absorb at least some of the power of the defective inverter 12 until a service engineer arrives at the location of the inverter device 15. Once the service engineer has repaired or replaced the defective inverter 12, the switch 25 is opened by the service engineer and the switches 23, 24 are then closed in order to place the inverter 12 back into operation. For safety reasons, the switch 25 is preferably opened or disconnected on site by a service engineer. Alternatively, said opening or disconnecting can also be triggered by means of the remote monitoring connection 29.

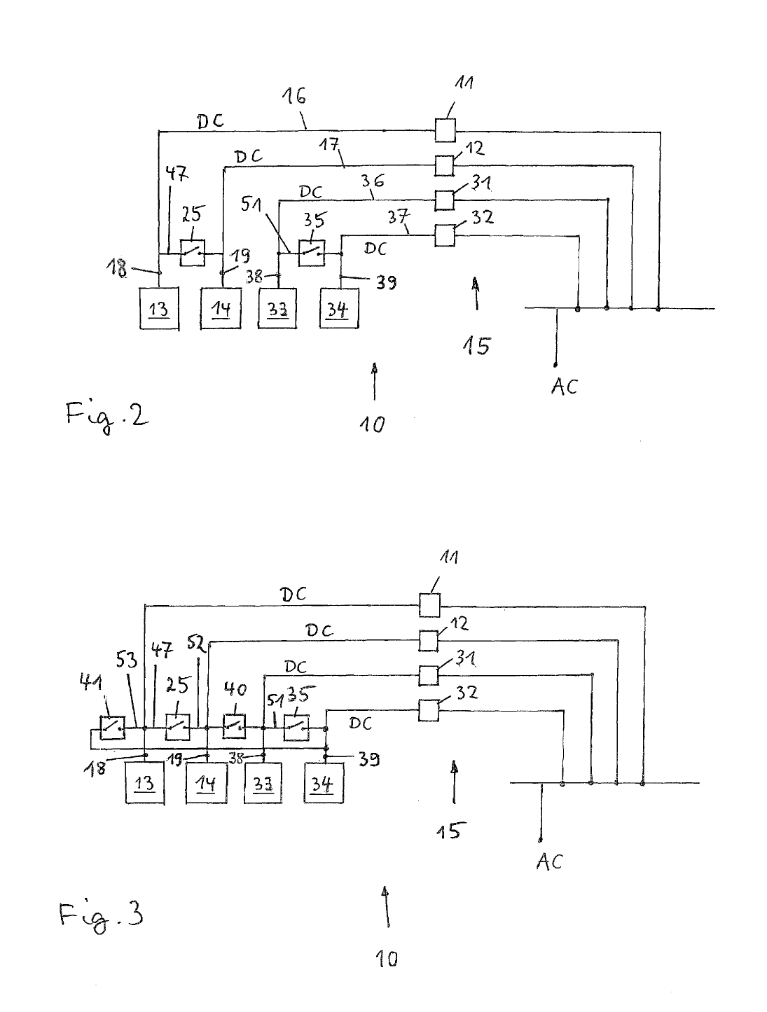

Advantageous embodiments for the general case of more than two inverters are shown schematically in FIGS. 2 and 3 using the example of four inverters 11, 12, 31, 32. In this case, the switches 21 to 24 for disconnecting the inverters, the control device 28 and the central remote maintenance system 30 have been omitted for the sake of clarity.

In the advantageous embodiment according to FIG. 2, the DC current paths 16, 17 and 36, 37 and the DC current inputs 18, and 38, 39 of two inverters 11, 12 and 31, 32, respectively, are connected to one another in pairs by means of a corresponding switch 25 and 35 via corresponding bridges 47, 51. In this case, the number of switches 25, 35 required is half as large as the number of inverters (for an even number of inverters). This renders each inverter 11, 12, 31, reliable with very little effort, since if any of the inverters were to fail, the corresponding DC current branch would be connected to the partner DC current branch.

In the advantageous embodiment according to FIG. 3, each DC current path 16, 17, 36, 37 and each DC current input 18, 19, 38, 39 is connected to two different DC current paths in each case by means of a switch 25, 35, 40, 41 in each case and corresponding bridges 47, 51, 52, 53, this specifically being advantageously in the form of a polygonal circuit, as shown in FIG. 3. In this case, the number of switches 25, 35, 40, 41 required corresponds to the number of inverters 11, 12, 31, 32. As a result, a substantially higher degree of reliability is provided with a reasonably higher amount of effort than in FIG. 2, since the failure of any two inverters is also manageable, and therefore all the DC current generators 13, 14, 33, 34 can be used until the service engineer arrives on site.

If, for example, the inverters 11, 12 fail at the same time, in FIG. 3 the switches 40 and 41 can be closed so that current generated by the DC current generator 13 can be converted in the inverter 32 and current generated by the DC current generator 14 can be converted in the inverter 31.

If, in a different case, the inverter 12 fails first, the switch 25 is closed, as depicted in FIG. 1. If the inverter 11 subsequently also fails before the service engineer is on site, the switch 25 can be re-opened and the switches 40, 41 can be closed instead; see above. As a result, a redundant degree of reliability is provided here in comparison with FIG.

1.

Other modes of connecting the DC current paths 16, 17, 36, 37 and the DC current inputs 18, 19, 38, 39, respectively, to those shown in FIGS. 2 and 3 are possible.

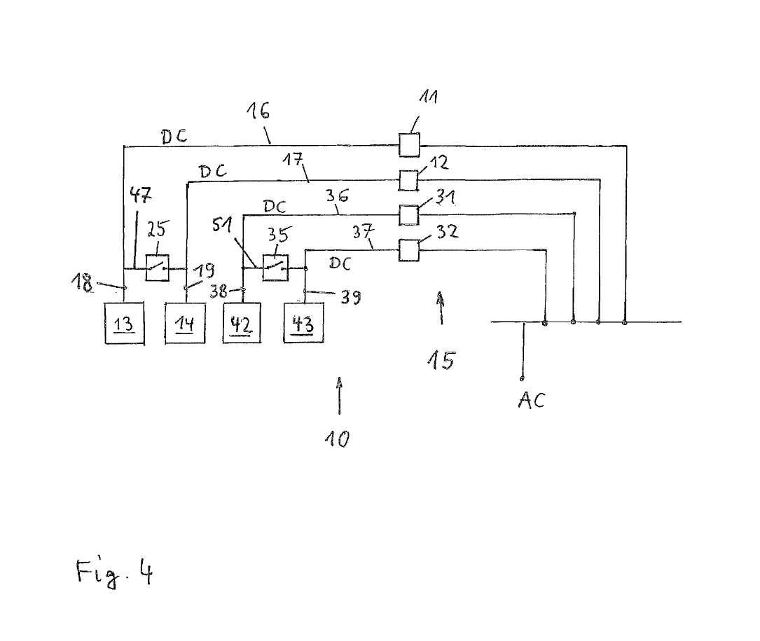

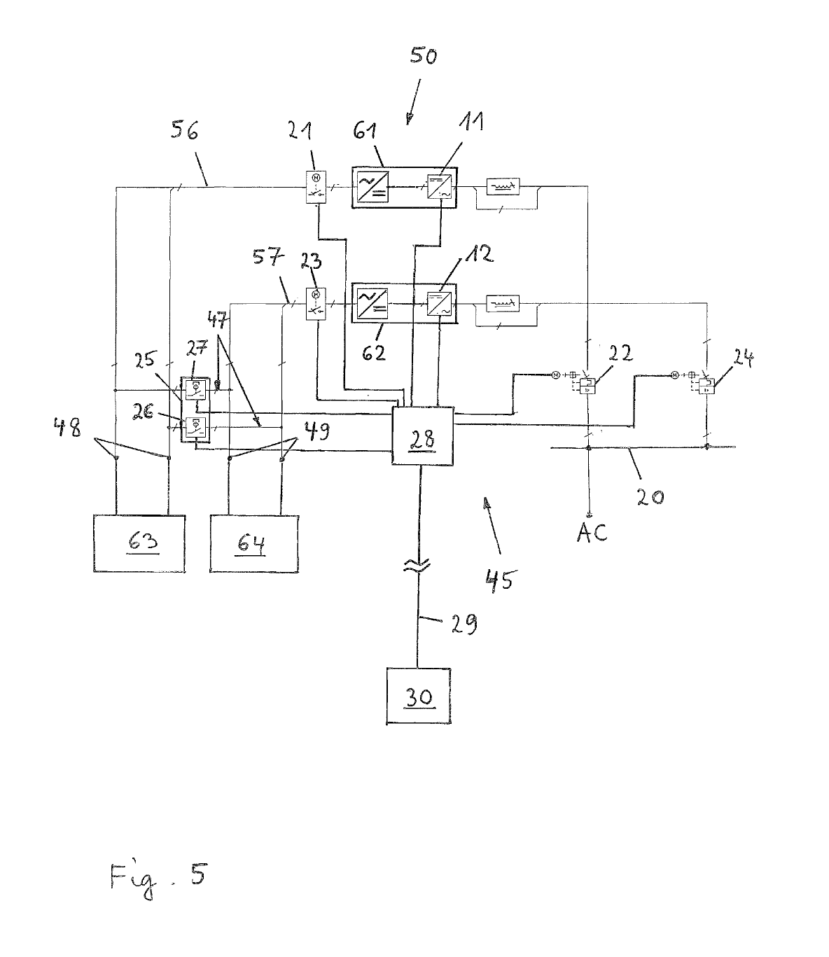

FIG. 4 shows a hybrid system 10 as another embodiment, in which, in addition to a first type of DC current generators 13, 14, in this case solar electricity generators, for example, another type of DC current generators 42, 43, is provided. These can be energy accumulators, in particular batteries, for example.

Such a hybrid system 10 operates as follows: at times when there is a high amount of solar power, i.e. a high amount of solar radiation or brightness, for example around midday, the solar electricity generators 13, 14 deliver more power than the AC mains can absorb. In this case, the system 10 is operated, in particular by suitably actuating the inverters 31, 32, such that the energy accumulators 42, 43 are charged.

The flow of current is then directed from the AC voltage side to the batteries 42, 43, the current converters 31, 32 associated with the batteries 42, 43 therefore operate as rectifiers, and the current direction is therefore reversed with respect to the current direction of the solar electricity generators 13, 14.

At times when there is a low amount of solar power, i.e. a low amount of solar radiation or brightness, for example at night, the solar electricity generators 13, 14 do not deliver any or only a small amount of power. In this case, the system 10 is operated, in particular by suitably actuating the inverters 31, 32, such that the energy accumulators 42, 43 feed energy into the AC mains. The flow of current is then directed from the batteries 42, 43 to the AC voltage side 20, the current converters 31, 32 associated with the batteries 42, 43 therefore operate as inverters, and the current direction is therefore the same as the current direction of the solar electricity generators 13, 14.

In embodiments having different types of DC current generators 13, 14 and 42, 43, the first type of DC current inputs 18, 19 are preferably connected to one another, for example in pairs, by means of the switch 25, the second type of DC current inputs 38, 39 are preferably connected to one another, for example in pairs, by means of the switch 35; see FIG. 4, etc. If a converter 11, 12, 31, 32 has failed, the switches 25, 35 are actuated in a similar way to the mode of operation described above with reference to FIGS. 1 to 3.

The embodiments according to FIGS. 1 to 4 can be applied to AC current generators 63, 64 instead of DC current generators 13, 14, 33, 34, 42, 43, without any problems. This is explained on the basis of FIG. 5. In these embodiments, the current converter device 45 comprises a plurality of parallel AC current branches 56, 57, each AC current branch 56, 57 comprising a converter 61, 62 and an AC current input 48, 49 for connection to one of the AC current generators 63, 64. The AC current generators 63, 64 can be different windings of the generator of a wind turbine 50, for example. According to the invention, as a result of an error being detected in one of the converters 61, 62, the control device 28 is designed to close the switch 25 in order to connect the AC current input 48, 49 of the faulty converter 62 to the AC current input 48 of an error-free converter 61.

1-15. (canceled)

16. A method for handling errors in an inverter device configured to convert a plurality of input DC currents from a corresponding plurality of DC current generators into a corresponding plurality of output AC currents, comprising:
providing an inverter device,
wherein the inverter device is configured to convert a plurality of input DC currents from a corresponding plurality of DC current generators into a corresponding plurality of output AC currents,
wherein the inverter device comprises:
a plurality of DC current branches,
wherein the DC current branches of the plurality of DC current branches are in parallel,
wherein each DC current branch of the plurality of DC current branches comprises:
a corresponding inverter of a corresponding plurality of inverters; and
a corresponding DC current input of a corresponding plurality of DC current inputs,
wherein each DC current input of the plurality of DC current inputs is configured to connect to a corresponding DC current generator of the plurality of DC current generators, such that a corresponding input DC current of the DC current generator inputted to the DC current input of the corresponding DC current branch is inputted to the corresponding inverter of the corresponding DC current branch in a first direction, and the inverter operates to:
invert the input DC current of the DC current generator; and
output a corresponding output AC current of the plurality of output AC currents;
detecting an error in a first inverter of a corresponding first DC current branch of the plurality of DC current branches by the inverter device; and
upon detecting the error in the first inverter, connecting a corresponding first DC current input of the first DC current branch to a corresponding second DC current input of a second DC current branch of the plurality of DC current branches,
wherein a corresponding second inverter of the second DC current branch is an error-free inverter.

17. The method according to claim 16,
wherein the inverter device further comprises:
a remote monitoring connection,
wherein the remote monitoring connection connects the inverter device to a central remote monitoring system, wherein the method further comprises:
transmitting the error in the first inverter of the first DC current branch detected by the inverter device to the central remote monitoring system via the remote monitoring connection;
receiving a control signal transmitted from the central remote monitoring system via the remote monitoring connection;
upon receiving the control signal from the central remote monitoring system, connecting the first DC current input of the first DC current branch and the second DC current input of the second DC current branch.

18. The method according to claim 16, further comprising:
disconnecting the first inverter of the first DC current branch from the inverter device before connecting the first DC current input of the first DC current branch and the second DC current input of the second DC current branch.

19. The method according to claim 16,
wherein after connecting the first DC current input of the first DC current branch and the second DC current input of the second DC current branch, the connection between the first DC current input of the first DC current branch and the second DC current input of the second DC current branch can only be disconnected by intervention of a person at a site of the inverter device.

20. The method according to claim 16, further comprising:
inputting one or more charging AC current to one or more inverters of a corresponding one or more DC current branches in a second direction opposite to the first direction such that the one or more inverters of the one or more DC current branches operate to:
rectify the one or more charging AC currents; and
output a corresponding one or more charging DC currents; and
charging at least one energy accumulator via the one or more charging DC currents.

21. The method according to claim 20, further comprising:
inputting a corresponding at least one output DC current from the at least one energy accumulator to a corresponding at least one DC current input of a corresponding at least one DC current branch of the plurality of DC current branches, such that the at least one output DC current is inputted to the corresponding at least one inverter of the at least one DC current branch and the at least one inverter operates to:
invert the at least one output DC current inputted to the at least one inverter; and
output a corresponding at least one output AC current,
so as to convert energy stored in at least one energy accumulator into the at least one output AC current.

22. An inverter device configured to convert a plurality of input DC currents from a corresponding plurality of DC current generators into a corresponding plurality of output AC currents, comprising:
a plurality of DC current branches,
wherein the DC current branches of the plurality of DC current branches are in parallel,
wherein each DC current branch of the plurality of DC current branches comprises:
a corresponding inverter of a corresponding plurality of inverters; and
a corresponding DC current input of a corresponding plurality of DC current inputs,
wherein each DC current input of the plurality of DC current inputs is configured to connect to a corresponding DC current generator of the plurality of DC current generators, such that a corresponding input DC current of the DC current generator inputted to the DC current input of the corresponding DC current branch is inputted to the corresponding inverter of the corresponding DC current branch in a first direction, and the inverter operates to:
invert the input DC current of the DC current generator; and
output a corresponding output AC current of the plurality of output AC currents;
an electronic control device,
a first switch configured to connect a first DC current input of a corresponding first DC current branch and a second DC current input of a corresponding second DC current branch,
wherein when an error is detected in a corresponding first inverter of the first DC current branch or a corresponding second inverter of the second DC current branch, the electronic control device closes the first switch in order to connect the first DC current input of the first DC current branch on the second DC current input of the second DC current branch, and
wherein the second inverter of the second DC current branch is an error-free inverter.

23. The inverter device according to claim 22, further comprising:
n additional switches, where n is an integer and n>0,
wherein each additional switch of the n additional switches is configured to connect a pair of DC current inputs of n/2 pairs of DC current inputs of 2n DC current inputs of the plurality of DC current inputs together.

24. The inverter device according to claim 22, further comprising:
n additional switches, where n is an integer and n>0,
wherein the plurality of DC current inputs is (n+1) DC current inputs,
wherein each additional switch of the n additional switches is configured to connect two DC current inputs of the plurality of DC current inputs together, such that each DC current input is connectable to two other DC current inputs by a corresponding two switches of the first switch and the n additional switches.

25. The inverter device according to claim 22,
wherein all of the DC current inputs of the plurality of DC current inputs are connected to one another in a polygonal circuit.

26. The inverter device according to claim 22, further comprising:
the plurality of DC current generators,
wherein the plurality of DC current generators comprises at least two different types of DC current generators.

27. The inverter device according to claim 26,
wherein each DC current input of the plurality of DC current inputs corresponding to a first type of DC current generator of the at least two different types of DC current generators can be connected to one another by switches of the at least one switch.

28. The inverter device according to claim 22,
wherein the plurality of DC current generators comprises at least one energy accumulator for storing energy and/or delivering energy.

29. A method for handling errors in a current converter device
configured to convert a plurality of input AC currents from a corresponding plurality of AC current generators into a corresponding plurality of output AC currents, comprising:
providing a current converter device,
wherein the current converter device is configured to convert a plurality of input AC currents from a corresponding plurality of AC current generators into a corresponding plurality of output AC currents,
wherein the current converter device comprises:
a plurality of AC current branches,
wherein the AC current branches of the plurality of AC current branches are in parallel,
wherein each AC current branch of the plurality of AC current branches comprises:
a corresponding converter of a corresponding plurality of converters; and
a corresponding AC current input of a corresponding plurality of AC current inputs,
wherein each AC current input of the plurality of AC current inputs is configured to connect to a corresponding AC current generator of the corresponding plurality of AC current generators;
detecting an error in a first converter of the plurality of converters by the current converter device, and upon detecting the error in the first converter of the plurality of converters, connecting a first AC current input of a corresponding first AC current branch and a second AC current input of a corresponding second AC current branch,
wherein the second converter of the second AC current branch is an error-free converter.

30. A current converter device configured to convert a plurality of input AC currents from a corresponding plurality of AC current generators into a corresponding plurality of output AC currents, comprising:
a plurality of AC current branches,
wherein the AC current branches of the plurality of AC current branches are in parallel,
wherein each AC current branch of the plurality of AC current branches comprises:
a corresponding converter of a corresponding plurality of converters; and
a corresponding AC current input of a corresponding plurality of AC current inputs,
wherein each AC current input of the plurality of AC current inputs is configured to connect to a corresponding AC current generator of the corresponding plurality of AC current generators;
an electronic control device,
a first switch configured to connect a first AC current input of a corresponding first AC current branch and a second AC current input of a corresponding second AC current branch,
wherein the electronic control device is configured such that upon detecting an error in a first converter of the first AC current branch or in a second converter of the second AC current branch, the electronic control device closes the first switch to connect the first AC current input of the first AC current branch and the second AC current input of the second AC current branch,
wherein the converter of the first converter and the second converter in which the error was detected is connected to an error-free converter.
